(19) United States
(12) Patent Application Publication
(10) Pub. No.: US 2012/0154217 A1
(43) Pub. Date: Jun. 21, 2012

(54) METHOD AND PROGRAM OF ACQUIRING NAVIGATION MESSAGE, GNSS RECEIVING APPARATUS, AND MOBILE TERMINAL

(75) Inventor: Takahiro Hosooka, Nishinomiya-City (JP)

(73) Assignee: FURUNO ELECTRIC COMPANY LIMITED, Nishinomiya-City, Hyogo-Pref. (JP)

(21) Appl. No.: 13/393,156

(22) PCT Filed: Aug. 18, 2010
(86) PCT No.: PCT/JP2010/063903

§ 371 Date: Feb. 28, 2012

(30) Foreign Application Priority Data
Aug. 31, 2009 (JP) 2009-199132

(51) Int. Cl. G01S 19/27; G01S 19/24

(52) U.S. Cl. 342/357.66; 342/357.63

(57) ABSTRACT

A navigation message acquiring unit acquires bit data per word from a received bit data row. Here, if continuous words constituting one subframe is failed to be acquired in one frame, only a word that is accurately decoded is stored. Here, final two bits in a word immediately prior to the accurately decoded word is also stored along with the accurately decoded word. If all of the words constituting the one subframe are successfully acquired in a plurality of frames, a phase match between the words is performed by using the final two bits in the word stored along with each of the words and immediately prior to the accurately decoded word, a supplemented subframe is formed by joining each of the phased matched words, and the navigation message acquiring unit outputs the supplemented subframe with time-of-week information.

### TECHNICAL FIELD

The present invention relates to a method and program of acquiring a navigation message by decoding GNSS positioning signals, and relates to a GNSS receiving apparatus and a mobile terminal using the above method and program.

### BACKGROUND ART

Currently, a very large number of devices (particularly mobile terminals) utilizing a positioning result using GPS positioning signals of a GPS that is one kind of GNSS, such as a navigation device and a mobile device equipped with a navigation function, exist.

When positioning is performed with such kind of device, the device calculates a pseudorange through receiving and demodulating the GPS positioning signals, and acquires navigation messages superimposed on the GPS positioning signals to utilize in positioning calculation.

FIG. 5 is configuration views showing a data configuration of the navigation message of the GPS.

The navigation message is transmitted at a bit rate of 50 bps and has a data configuration in which five frames FF where the entire number of data bits of each frame is 1,500 (thirty seconds in a time axis) is set as one group, and the group is repeated.

Each of the frames FF is divided into five subframes SF1 to SF5 where each of them is constituted of 300 bits (six seconds). The subframe SF1 on the head side of the frame FF has, for example, satellite health information, the subframes SF2 and SF3 have an ephemeris, and the subframes SF4 and SF5 have an almanac.

In the subframes SF2 and SF3 having the ephemeris, the same data row is transmitted in each frame FF until the ephemeris is updated by a control segment. In the subframes SF4 and SF5 having the almanac, each frame FF has a different data row and it is set so that the complete almanac is obtained through twenty five frames. Note that, the groups for the twenty five frames constituting the almanac are also sequentially repeated.

Each of the subframes SF1 to SF5 is constituted with ten words W1 to W10 where each of them is constituted with thirty bits (0.6 seconds), and in each of the words W1 to W10, twenty four bits on the head side of the corresponding subframe SF serve as navigation data, and six bits on the tail side serve as parity bits. A synchronization pattern is arranged at the head of the word W1 and time-of-week data (Z count) is contained in the word W2.

When such a navigation message cannot be acquired, for example, in a case where a C/N of the receiving signal is low, various information for the positioning calculation cannot be acquired, and therefore, a problem, such as a positioning accuracy degrading, occurs. Especially, the ephemeris includes detailed information, such as, satellite clock error information and orbit information of the positioning satellite that is the transmission source, therefore, it is needed for a highly accurate positioning calculation and desired to be acquired as much as possible.

Therefore, in Patent Document 1, common data between frames is differential demodulated to improve a substantial C/N, and a navigation message is effectively acquired.

Further, in Patent Document 2, a preamble of a subframe is detected. If a data row constituting the subframe cannot be acquired in continuous words constituting a single subframe, the data row is acquired per word intermittently, and when all of the words for constituting the subframe are successfully detected to be acquired, a navigation message is acquired from the subframe.

### REFERENCE DOCUMENT(S) OF CONVENTIONAL ART

### Patent Documents

Patent Document 1: JP2002-530627A

Patent Document 2: JP2000-056007A

### DISCLOSURE OF THE INVENTION

### Problem(S) to be Solved by the Invention

However, with the device in Patent Document 1, although the possibility of acquiring the navigation message increases due to the improvement in the substantial C/N, the navigation message is still not sure to be acquired.

Further, conventionally, if the navigation message cannot be acquired in one subframe, demodulated bit data is generally discarded per subframe until the navigation data is acquired. Then, processing of demodulating bit data of another subframe in a new frame again and acquiring the navigation message per subframe is repeated.

Meanwhile, currently, a high sensitivity is required for a GPS receiving apparatus, in which it is desired that even the GPS positioning signal with a low C/N in reception signal to be acquired and tracked so that the navigation message can be used, whereas, the GPS positioning signal with a high C/N in reception signal does not raise a problem in the acquisition and tracking.

Under such a poor reception environment where, for example, the C/N is low, a bit error rate becomes extremely high, and the efficiency becomes extremely low if the acquisition and the discarding are determined per subframe constituted with 300 bits, and, in some cases, the navigation message cannot be acquired.

Therefore, in the method of Patent Document 2, after the preamble of the subframe is detected, data is acquired while performing parity check per thirty bits with a reference point being a bit position of the preamble, that is per number of data constituting the word, and the data is acquired per word. Further, such data acquisition processing is repeated until all the words for constituting the subframe is acquired. In this method, because the data is acquired per word, the efficiency is higher than acquiring the data per subframe. However, the preamble always needs to be found for each subframe and the processing per word cannot be performed, and thereby, there is a case where this method may be close to or the same as the acquisition per subframe in efficiency.

The object of the present invention is to provide a GPS receiving apparatus that can surely and efficiently acquire a navigation message, especially an ephemeris, and provide a method of acquiring the navigation message.

This invention relates to a method of acquiring a navigation message from a received GNSS positioning signal. This method of acquiring the navigation message includes acquiring each of words constituting a subframe, creating, when at least one word required for acquiring the navigation message is failed to be acquired in the subframe, a supplemented subframe by supplementing the word failed to be acquired, with a word in another subframe acquired at a timing different from the word failed to be acquired, acquiring the navigation message based on the supplemented subframe, and acquiring, when the supplemented subframe is created with words in a plurality of subframes, time-of-week data contained in a particular word of the subframe, and determining, based on the time-of-week data, a subframe to which each of words constituting another subframe where time-of-week data is failed to be acquired belongs.

In this method, acquiring and discarding the navigation message is not performed per subframe as in the conventional method, but performed per word. This uses that, for each subframe that has an ephemeris in a navigation message, the same subframe is set to be repeatedly transmitted and each information configuring the ephemeris is not contained in a plurality of words and, therefore, even if the processing of acquisition and discarding per word is performed, a problem does not arise. Further, if words for a predetermined subframe are not completely accurately decoded in one frame, a navigation message acquiring unit repeats the acquisition per word in a plurality of frames. Once the words constituting the predetermined subframe are completely accurately decoded, the navigation message acquiring unit arranges each of the words obtained from the plurality of frames, and outputs them as one subframe (supplemented subframe).

Thus, the acquisition and discarding is determined per word constituting the subframe, that is, per word in which the number of bits is smaller than in the subframe, and therefore, the navigation message is efficiently acquired.

Further, in this method, the time-of-week data (Z count) contained in a HOW word (indicating “Hand Over Word”) of the GNSS positioning signal is used. The time-of-week data is a value counted up for every subframe, and can uniquely correspond to the number of each of the subframes. Therefore, the subfame can be identified by acquiring the time-of-week data. Here, the time-of-week data is contained in a word W2 of each of the subframes with the HOW word, and therefore, each of the words in the corresponding subframe can be identified with a bit data row in the word W2 being a reference. Thereby, even if the plurality of words constituting the predetermined subframe are acquired from the plurality of frames, the subframe to which each word belongs can accurately be determined.

Thus, by using the method of the invention, the navigation message acquiring processing can be performed per word, and even if a particular bit data row is not necessarily acquired at all times, the supplemented subframe where words of the plurality of subframes are combined to each other can accurately be created.

Further, this invention relates to a method of acquiring a navigation message from a received GNSS positioning signal. This method of acquiring the navigation message includes acquiring each of words constituting a subframe, creating, when at least one word required for acquiring the navigation message is failed to be acquired in the subframe, a supplemented subframe by supplementing the word failed to be acquired, with a word in another subframe acquired at a timing different from the word failed to be acquired, acquiring the navigation message based on the supplemented subframe, and adjusting, when the supplemented subframe is created with words in a plurality of subframes, the words constituting the supplemented subframe to be in the same phase.

In this method, at a time of demodulation processing, the phase may invert per word, therefore, phase adjusting processing is performed so that each of the words is in the same phase thereamong and then, the supplemented subframe is created. Thereby, for the navigation message acquired from the supplemented subframe, the phase inversion among the words is not occurred, and the accurate navigation message can be acquired.

Further, the method of acquiring the navigation message of this invention may further include adjusting, when the supplemented subframe is created with words in a plurality of subframes, the words constituting the supplemented subframe to be in the same phase.

In this method, the two methods described above are combined. Thereby, the navigation message can efficiently and accurately be acquired.

Further, in the method of acquiring the navigation message of this invention, the words constituting the supplement subframe may be adjusted to be in the same phase based on a bit data row constituting one word and a bit data row with a predetermined number of forward bits from a final bit in a word immediately prior to the one word.

In this method, the specific method of adjusting the words constituting the supplemented subframe described above to be in the same phase. Specifically, in the arrangement of the words by this method, if the bit data on the tail side of the word stored at the same time as and immediately preceding to the word is in the same phase as the bit data on the tail side of the word arranged immediately prior to the immediately preceding word, the phase inversion is not occurred, the arrangement processing is performed. On the other hand, if the phases of these bit data are inverted, the phase inversion among the words is determined to be occurred, and the arrangement processing is performed after the inverting processing. Thereby, the in-phase processing among the words can accurately be performed.

Further, the method of acquiring the navigation message of this invention may further include detecting a head position of the subframe based on a unique bit pattern contained in the subframe, and identifying a position of each of the words in the subframe based on the head position.

This method indicates a method of further identifying the word position and uses that the unique bit pattern is provided at the head of the subframe. Further, by detecting the head position of the subframe, the word position can also be identified from a bit amount from the head position.

Further, in the method of acquiring the navigation message of this invention, the navigation message may be an ephemeris, and when the ephemeris is updated, the supplemented subframe may be created with a word acquired after the update.

In this method, once the ephemeris is updated, the data of the subframe containing the ephemeris is also updated. Therefore, by discarding the word stored along with the update and re-acquiring data, the information relating to the ephemerides before and after the update can be prevented from being mixed in one subframe constituted with word by word.

Further, in the method of acquiring the navigation message of this invention, the subframe may be constituted with a predetermined number of words, and the word may be constituted with a bit data row with a predetermined number of bits.

In this method, the specific data configuration of the subframe is indicated.

Further, this invention relates to a method of creating a subframe. This method of creating the subframe includes acquiring each of words constituting a subframe, creating, when at least one word required for constituting the subframe is failed to be acquired, a supplemented subframe by supplementing the word failed to be acquired, with a word in another subframe acquired at a timing different from the word failed to be acquired, and acquiring, when the supplemented subframe is created with words in a plurality of subframes, time point data contained in a particular word of the subframe, and determining, based on the time point data, a subframe to which each of words constituting another subframe from which the time point data is failed to be acquired belongs.

Further, this invention relates to a method of creating a subframe. This method of creating the subframe includes acquiring each of words constituting a subframe, creating, when at least one word required for constituting the subframe is failed to be acquired, a supplemented subframe by supplementing the word failed to be acquired, with a word in another subframe acquired at a timing different from the word failed to be acquired, and adjusting, when the supplemented subframe is created with words in a plurality of subframes, the words constituting the supplemented subframe to be in the same phase.

These methods indicate that even with a subframe that does not contain the navigation message described above, by the similar processing to the subframe containing the navigation message described above, the subframe can be created.

Note that, in the above description, although the method of acquiring the navigation message is mainly explained, the similar effects can be obtained with a program for causing a computer to execute each processing of realizing the method of acquiring the navigation message, and a GNSS receiving apparatus and a mobile terminal including a mechanical configuration for realizing the method of acquiring the navigation message.

### Effect of the Invention

According to the invention, a navigation message superimposed on a GPS positioning signal can surely and effectively be acquired. Thereby, even in a poor reception environment, highly accurate positioning can be performed in comparatively high speed and surely.

### BRIEF DESCRIPTION OF THE DRAWINGS

FIG. 1 is a block diagram showing a main configuration of a GPS receiving apparatus 100 according to an embodiment of the invention.

FIG. 2 is a flowchart showing a main flow of a navigation message acquiring unit 14.

FIG. 3 is a flowchart showing a detailed flow of data generation processing of a subframe of the navigation message acquiring unit 14.

FIG. 4 is views showing specific concepts of a data formation in a supplemented subframe.

FIG. 5 is a configuration views showing a data configuration of a navigation message of a GPS.

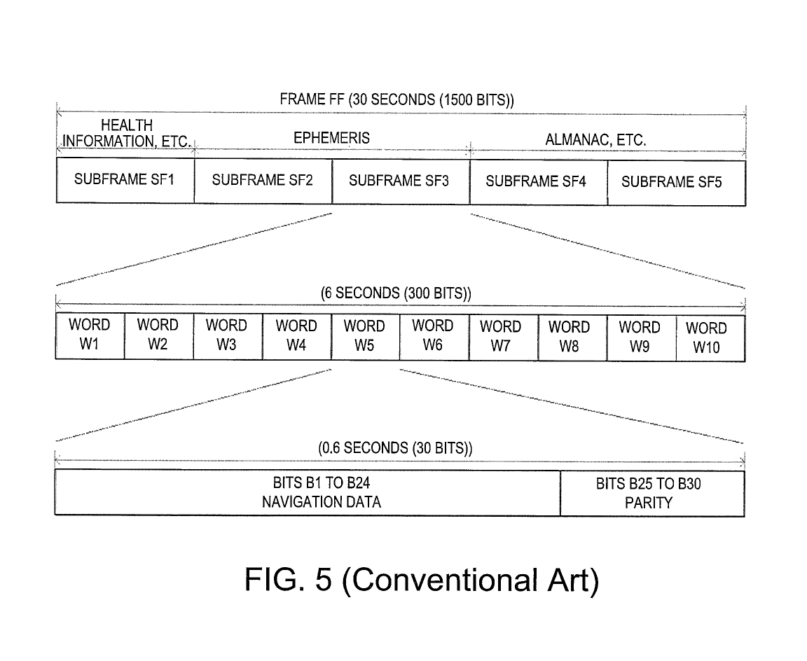

### MODE OF CARRYING OUT THE INVENTION

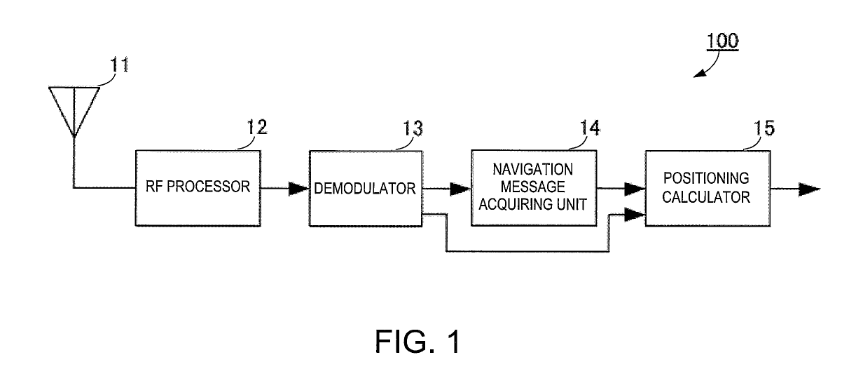

A GPS receiving apparatus and a method of acquiring a navigation message according to an embodiment of the present invention is explained with reference to the drawings. FIG. 1 is a block diagram showing a main configuration of a GPS receiving apparatus 100 of this embodiment. Note that, in this embodiment, although a GPS is explained as an example, the following acquiring method and configuration can be applied to other GNSS using a similar method of transmitting the navigation message. Further, in this embodiment, although simply the GPS receiving apparatus is explained as an example, the following acquiring method and configuration can be applied to various kinds of mobile terminals including the GPS receiving apparatus and implemented with an application that uses a positioning result calculated by the GPS receiving apparatus (e.g., a mobile phone, a car navigation system, a PND, a camera, a watch).

Further, in the following explanation, the GPS receiving apparatus having a mechanical configuration for achieving the navigation message acquiring method is explained as an example; however, through implementing, as software, by storing a navigation message acquiring program in which processing for achieving the navigation message acquiring method described in this embodiment is programmed, the navigation message acquiring method shown as follows can be achieved by processing of executing the navigation message acquiring program, which is implemented as the software, by, for example, a CPU.

The GPS receiving apparatus 100 includes a positioning signal reception antenna 11, an RF processor 12, a demodulator 13, a navigation message acquiring unit 14, and a positioning calculator 15.

The positioning signal reception antenna 11 receives radio signals for positioning that are sent from GPS positioning satellites. The radio signal for positioning (hereinafter, it is referred to as the “positioning signal”) is a signal in which a carrier wave formed with a predetermined single frequency is spectrally spread by a spread code, which is set for each positioning satellite, and the navigation message. The positioning signal reception antenna 11 converts the reception signal into an electrical signal and outputs it to the RF processor 12.

The RF processor 12 down-converts the frequency of the reception signal, generates a to-be-correlation-processed signal constituted with a middle frequency signal with a predetermined frequency and a baseband signal, and outputs it to the demodulator 13.

The demodulator 13 performs code acquisition processing based on a result of correlation processing between the to-be-correlation-processed signal and a replica code, then, executes code tracking processing and carrier tracking processing using, for example, Early-Late correlation processing, and performs a de-spreading of the reception signal by using the Prompt correlation processing result. Here, if a tracking accuracy is sufficiently obtained, a code is locked, and a highly accurate code correlation value is obtained by the Prompt correlation processing, the de-spread signal becomes a state to which only the navigation data is superimposed. The demodulator 13 generates a bit data row configured with a predetermined bit length by multiplying the de-spread signal (correlation processing data), and outputs it to the navigation message acquiring unit 14. Note that, when the code tracking processing is performed, the demodulator 13 calculates a pseudorange based on a code tracking result as well as calculates carrier frequency information based on the carrier tracking result, and outputs the pseudorange and the carrier frequency information to the positioning calculator 15.

The navigation message acquiring unit 14, although the detailed method is described later, acquires the navigation message from the bit data row inputted from the demodulator 13 and outputs it to the positioning calculator 15. Here, the navigation message acquiring unit 14 acquires the navigation message per word and outputs it per subframe. Here, if the navigation message acquiring unit 14 confirms that, among words W1 to W10 constituting a single subframe, a time-of-week data (Z count) uniquely set for the subframe by a HOW word of the word W2, and the words W3 to W10 to be used at least as navigation data are successfully acquired, the navigation message acquiring unit 14 outputs these to the positioning calculator 15.

Further, if all the words W3 to W10 are not collected in the single subframe, the navigation message acquiring unit 14 only stores word(s) that is accurately decode d, repeatedly executes the above processing on multiple number of frames, and, when all the words W3 to W10 are collected, matches phases thereof to be joined therebetween and outputs them to the positioning calculator 15.

The positioning calculator 15 performs the positioning calculation based on the navigation message from the navigation message acquiring unit 14 and the pseudorange and the carrier frequency information from the demodulator 13.

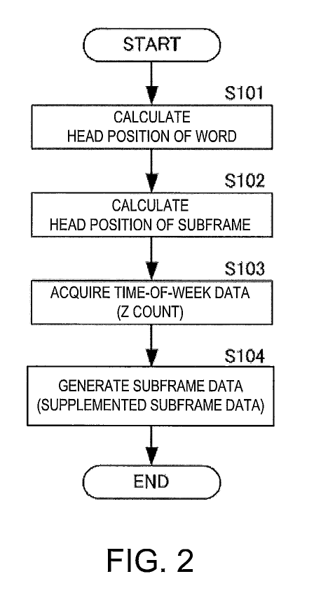

Next, the method of acquiring the navigation message executed by the navigation message acquiring unit 14 is explained in detail with reference to the drawings. FIG. 2 is a flowchart showing a main flow of the navigation message acquiring unit 14.

After the navigation message acquiring unit 14 acquires the bit data row from the demodulator 13, it calculates a head position of the word by parity checking the bit data for every 30 bits that is a unit of the bit configuration of the word (S101). For example, the navigation message acquiring unit 14 repeats, while shifting by one bit, the processing of acquiring the data for the thirty bits from the bit data row and performing the parity check thereon, detects the thirty bits that passed the parity check as one word, and calculates the head position of the word.

Next, the navigation message acquiring unit 14 matches a segmentized bit data row per word with a synchronization pattern that is set at the head of the subframe and, thereby, calculates a head position of the subframe (S102). This calculation uses that in GPS, the word W1 of the subframe has the synchronization pattern set in advance, and the navigation message acquiring unit 14, by matching the synchronization pattern with each of the detected words, detects the word W1 and calculates the head position of the subframe.

Next, the navigation message acquiring unit 14 reads the word W2 next to the word W1 having the calculated subframe head position, and acquires the time-of-week data (Z count) (S103). By reading the time-of-week data, the subframe is identified among any of the subframes SF1 to SF5 in a frame. Thereby, the subframe to which each of the words belongs can also be determined.

Note that, even if the time-of-week data cannot be acquired because, for example, the word W2 is determined to be the bit data that cannot accurately be decoded, with a count value from a counter, the navigation message acquiring unit 14 can identify the subframes and the words. That is, the navigation message acquiring unit 14 includes the counter and, once the time-of-week data is successfully acquired, starts counting having a timing of the acquisition as a reference. Here, the orders of the respective subframes SF1 to SF5 and the words W1 to W10 of each subframe are permanent, and a bit transmission rate of the navigation message superimposed on the GPS positioning signals is constant. Therefore, as long as the time-of-week data is successfully acquired even once and further the counter counts at a constant time interval having the timing being a reference, each subframe and word can be identified.

Next, the navigation message acquiring unit 14 generates subframe data by using the bit data row of each word (S104).

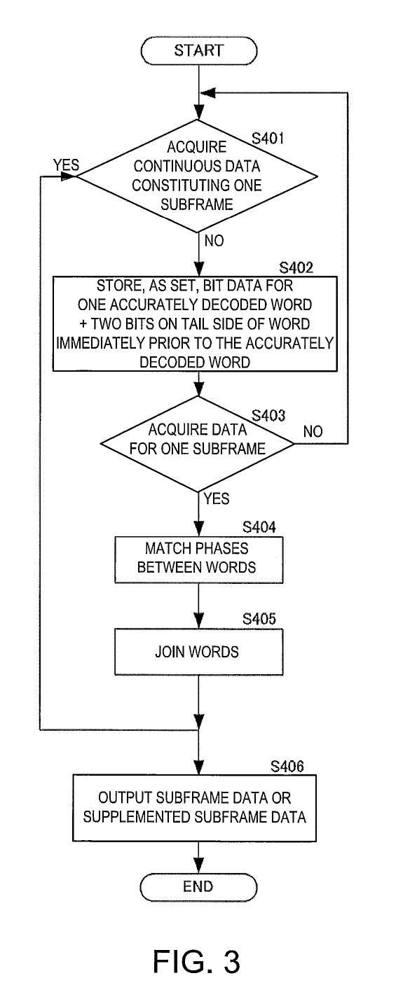

FIG. 3 is a flowchart showing a detailed flow of subframe data generating processing.

After the navigation message acquiring unit 14 successfully acquires the continuous words W3 to W10 constituting one subframe through the accurate decoding by identifying the above subframes SF1 to SF5 and the words W1 to W10 (S401: YES), the navigation message acquiring unit 14 outputs to the positioning calculator 15 the bit data row constituted with these words W3 to W10 and the time-of-week data corresponding to the bit data row as a set (S406). Here, if the time-of-week data is failed to be acquired from the word W2, the navigation message acquiring unit 14 sets the time-of-week data based on the above count value and outputs it.

If the words W3 to W10 constituting the subframe are not completely collected (S401: NO), the navigation message acquiring unit 14 only stores the bit data of the word accurately decoded (S402). Here, the navigation message acquiring unit 14 stores the bit data as a storing bit row M in which the bit data of the word to be stored and the two bits on the tail side of the word immediately prior to the word to be stored are a set.

The navigation message acquiring unit 14 repeatedly executes such acquisition processing of the bit data row per word until the words W3 to W10 constituting the subframe are completely collected (S403: NO→S401).

If, as a result of acquiring the bit data row per word over a plurality frames, the words W3 to W10 constituting the subframe are completely collected (S403: YES), the navigation message acquiring unit 14 detects phase relations among the words W3 to W10 and matches phases among the words (S404). This is because, in a case where a reception environment is poor and a C/N is low, a level of the reception signal to be tracked (to-be-correlation processed signal) also becomes low and, thereby, when locking the phase in the tracking loop, the phase may be inverted. That is, a bit that has a relation of “0, 1” may change to “1, 0” immediately thereafter. Therefore, processing of having the phases to conform to each other needs to be performed.

Specifically, the navigation message acquiring unit 14 performs processing of matching the phases to each other in the order starting from the word W3, then W4, W5, . . . , to W10 (phase matching processing).

First, for the phase of the word W3, the navigation message acquiring unit 14 acquires the starting two bits of a storing bit row M3 containing the word W3 and, if the two bits are both “0”, that is, the bit row of “0, 0”, the navigation message acquiring unit 14 determines that the word W3 is in a non-inverted state. On the other hand, if the two bits are both “1”, that is, the bit row of “1, 1”, the navigation message acquiring unit 14 determines that the word W3 is in an inverted state. This is based on that in the navigation message of GPS, the ending two bits of the word W2 are always set to “0, 0.” When the navigation message acquiring unit 14 determines that the word W3 is in the inverted state, it performs processing of inverting the complete bit data constituting the word W3, that is, the bit data “0” is converted into bit data “1”, and the bit data “1” is converted into bit data “0.”

Next, for each of the words W4 to W10, the navigation message acquiring unit 14 acquires starting two bits of a storing bit row Mk containing a word Wk (“k” is an integer between 4 to 10). If the two bits have the same phase as the ending two bits of a word Wk−1 immediately prior thereto, respectively, the navigation message acquiring unit 14 determines that the word Wk is in the non-inverted state. On the other hand, if the two bits have the reversed phase to the ending two bits of a word Wk−1 immediately prior thereto, respectively, the navigation message acquiring unit 14 determines that the word Wk is in the inverted state. When the navigation message acquiring unit 14 determines that the word Wk is in the inverted state, it performs processing of inverting the complete bit data constituting the word Wk.

After the navigation message acquiring unit 14 performs the phase matching processing among the respective words, it discards the bit data portion for the phase matching, that is, the bit data at the tail of the word that is immediately prior to the target word and stored along with the target word. Then, the navigation message acquiring unit 14 joins the words W3 to W10 constituting the subframe (S405), and outputs them to the positioning calculator 15 together with the time-of-week data of the subframe (S406). Here, the subframe constituted with the words over the plurality of frames corresponds to the “supplemented subframe” of the present invention.

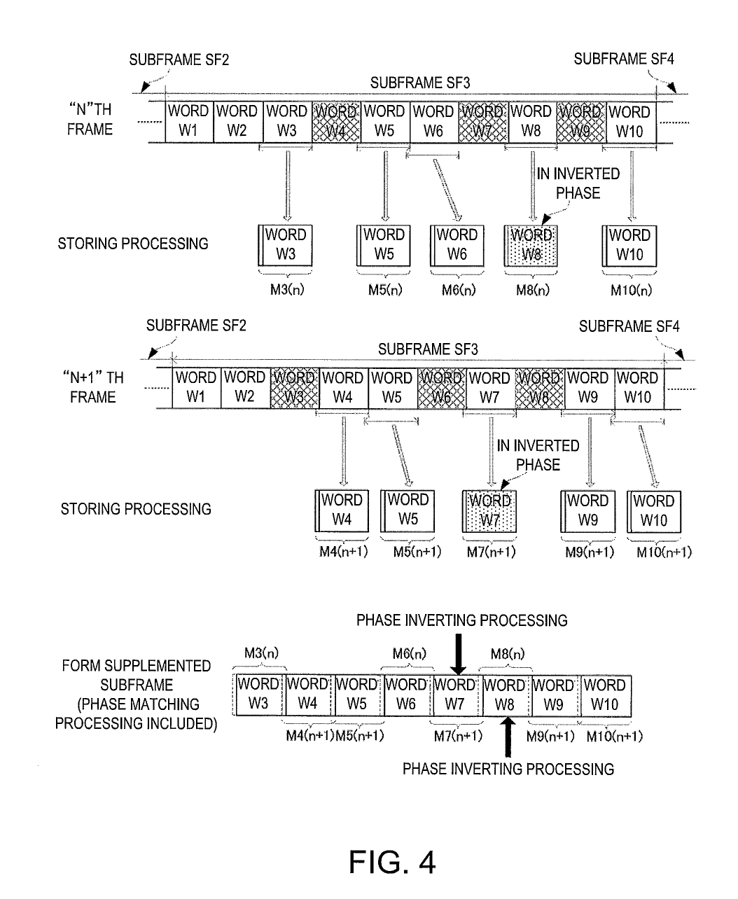

Next, a specific example of the data forming processing of the subframe is explained with reference to FIG. 4.

FIG. 4 is views showing specific concepts of the data formation of the subframe by being supplemented.

As shown in FIG. 4, it is assumed that the words W3, W5, W6, W8 and W10 of the subframe SF3 are accurately decoded and the words W4, W7 and W9 cannot be decoded in the Nth frame FF.

In this case, the navigation message acquiring unit 14 stores a storing bit row M3(n) constituted with the word W3 and the ending two bits of the word W2, a storing bit row M5(n) constituted with the word W5 and the ending two bits of the word W4, a storing bit row M6(n) constituted with the word W6 and the ending two bits of the word W5, a storing bit row M8(n) constituted with the word W8 and the ending two bits of the word W7, and a storing bit row M10(n) constituted with the word W10 and the ending two bits of the word W9.

Next, it is assumed that the words W4, W5, W7, W9 and W10 of the subframe SF3 are accurately decoded and the words W3, W6 and W8 cannot be decoded in the N+1th frame FF.

In this case, the navigation message acquiring unit 14 stores a storing bit row M4(n+1) constituted with the word W4 and the ending two bits of the word W3, a storing bit row M5(n+1) constituted with the word W5 and the ending two bits of the word W4, a storing bit row M7(n+1) constituted with the word W7 and the ending two bits of the word W6, a storing bit row M9(n+1) constituted with the word W9 and the ending two bits of the word W8, and a storing bit row M10(n+1) constituted with the word W10 and the ending two bits of the word W9.

Here, the navigation message acquiring unit 14 stores by overwriting the storing bit row M5(n) with the storing bit row M5(n+1), and the storing bit row M10(n) with the storing bit row M10(n+1).

If the words W3 to W10 of the subframe SF3 are completely collected in the Nth frame and the N+1th frame, the navigation message acquiring unit 14 executes the phase matching processing of the words W3 to W10 sequentially starting from the word W3.

Here, as shown in FIG. 4, if the phases of the words W7 and W8 are inverted, when the navigation message acquiring unit 14 detects the phase of the word W7, it detects that the starting two bits of the storing bit row M7(n+1) is in an inverted phase to that of the ending two bits of the word W6 having already been performed with the phase detection. The navigation message acquiring unit 14 executes the phase inverting processing on all of the bit data of the storing bit row M7(n+1) containing the word W7 based on the detection of the inverted phase and stores the bit data again.

Next, when the navigation message acquiring unit 14 detects the phase of the word W8, it detects that the starting two bits of the storing bit row M8(n) is in an inverted phase to that of the ending two bits of the word W7 having already been performed with the phase detection and the phase inverting processing. The navigation message acquiring unit 14 executes the phase inverting processing on all of the bit data of the of the storing bit row M8(n) containing the word W8 based on the detection of the inverted phase and stores the bit data again.

After the navigation message acquiring unit 14 performs the phase matching processing so that the phase relations among the words W3 to W10 are completely uniform, the navigation message acquiring unit 14 extracts only the word portions from the storing bit row, respectively, joins them with each other sequentially, and outputs them to the positioning calculator 15.

By using the navigation message acquiring method, the determination of outputting and discarding the complete bit data per subframe is not needed to be performed as in the conventional art, and the form of the navigation message can effectively be utilized and the navigation message can be acquired further accurately and efficiently. Especially, although, when the reception environment is poor, a possibility to be able to acquire the complete bit data per subframe is extremely low and the navigation message may not be acquired at all, by using the navigation message acquiring method, the navigation message can efficiently be acquired even with the poor reception environment.

Note that, in the above embodiment, the example in which the bit data is stored per single word is explained; however, when the accurately decoded words continuously exist (e.g., words W5 and W6 in the Nth frame in to FIG. 4), these continuous words can be stored as one storing unit.

Further, in the above embodiment, the example in which the word accurately decoded in one frame is used as it is, is explained; however, only the word that is accurately decoded over a plurality of times may be used.

Further, in the above embodiment, the processing during a period in which ephemeris is constant is explained; however, in a case where the period crosses a timing of updating the ephemeris, the words stored until the update timings is discarded collectively, and the acquisition of word is performed again. Thereby, a formation of an inappropriate subframe in which words configured by different ephemerides are combined can be prevented.

Further, in the above embodiment, the method of acquiring the ephemeris is explained; however, this method can be used for acquiring almanac. That is, a data group of the navigation message constituted with twenty-five frames may be acquired a plurality of times, and supplemented frame data such as the case of the above ephemeris may be formed.

Moreover, in the above embodiment, the method of creating the subframe containing the navigation message is explained; however, even if the navigation message is not contained, the method of creating the subframe can be applied to any of a transmission signal of a transmission system with the above word configuration, the subframe configuration, and the frame configuration.

### DESCRIPTION OF NUMERALS

11: Positioning Signal Reception Antenna; 12: RF Processor; 13: Demodulator; 14: Navigation Message Acquiring Unit; and 15: Positioning Calculator.

1-14. (canceled)

15. A method of acquiring a navigation message from a received GNSS positioning signal, comprising:
acquiring each of words constituting a subframe;
creating, when at least one word required for acquiring the navigation message is failed to be acquired in the subframe, a supplemented subframe by supplementing the word failed to be acquired, with a word in another subframe acquired at a timing different from the word failed to be acquired;
acquiring the navigation message based on the supplemented subframe; and
acquiring, when the supplemented subframe is created with words in a plurality of subframes, time-of-week data contained in a particular word of the subframe, and determining, based on the time-of-week data, a subframe to which each of words constituting another subframe where time-of-week data is failed to be acquired belongs.

16. A method of acquiring a navigation message from a received GNSS positioning signal, comprising:
acquiring each of words constituting a subframe;
creating, when at least one word required for acquiring the navigation message is failed to be acquired in the subframe, a supplemented subframe by supplementing the word failed to be acquired, with a word in another subframe acquired at a timing different from the word failed to be acquired;
acquiring the navigation message based on the supplemented subframe; and
adjusting, when the supplemented subframe is created with words in a plurality of subframes, the words constituting the supplemented subframe to be in the same phase.

17. The method of acquiring the navigation message of claim 15, further comprising adjusting, when the supplemented subframe is created with words in a plurality of subframes, the words constituting the supplemented subframe to be in the same phase.

18. The method of acquiring the navigation message of claim 16, wherein the words constituting the supplement subframe are adjusted to be in the same phase based on a bit data row constituting one word and a bit data row with a predetermined number of forward bits from a final bit in a word immediately prior to the one word.

19. The method of acquiring the navigation message of claim 15, further comprising:
detecting a head position of the subframe based on a unique bit pattern contained in the subframe; and
identifying a position of each of the words in the subframe based on the head position.

20. The method of acquiring the navigation message of claim 15, wherein the navigation message is an ephemeris, and
wherein when the ephemeris is updated, the supplemented subframe is created with a word acquired after the update.

21. The method of acquiring the navigation message of claim 15, wherein the subframe is constituted with a predetermined number of words, and
wherein the word is constituted with a bit data row with a predetermined number of bits.

22. A program for causing a computer to execute processing of acquiring a navigation message from a received GNSS positioning signal, comprising:
causing a computer to acquire each of words constituting a subframe;
causing a computer to create, when at least one word required for acquiring the navigation message is failed to be acquired in the subframe, a supplemented subframe by supplementing the word failed to be acquired, with a word in another subframe acquired at a timing different from the word failed to be acquired;
causing a computer to acquire the navigation message based on the supplemented subframe; and
causing a computer to acquire, when the supplemented subframe is created with words in a plurality of subframes, time-of-week data contained in a particular word of the subframe, and causing a computer to determine, based on the time-of-week data, a subframe to which each of words constituting another subframe from which time-of-week data is failed to be acquired belongs.

23. A program for causing a computer to execute processing of acquiring a navigation message from a received GNSS positioning signal, comprising:
causing a computer to acquire each of words constituting a subframe;
causing a computer to create, when at least one word required for acquiring the navigation message is failed to be acquired in the subframe, a supplemented subframe by supplementing the word failed to be acquired, with a word in another subframe acquired at a timing different from the word failed to be acquired;
causing a computer to acquire the navigation message based on the supplemented subframe;
causing a computer to adjust, when the supplemented subframe is created with words in a plurality of subframes, the words constituting the supplemented subframe to be in the same phase.

24. A GNSS receiving apparatus for acquiring a navigation message from a received GNSS positioning signal, comprising:
a demodulator for demodulating the GNSS positioning signal into bit data; and
a navigation message acquiring unit for acquiring each of words constituting a subframe, creating, when at least one word required for acquiring the navigation message is failed to be acquired in the subframe, a supplemented subframe by supplementing the word failed to be acquired, with a word in another subframe acquired at a timing different from the word failed to be acquired, and acquiring the navigation message based on the supplemented subframe,
wherein when the supplemented subframe is created with words in a plurality of subframes, the navigation message acquiring unit adjusts the words constituting the supplemented subframe to be in the same phase.

25. A GNSS receiving apparatus for acquiring a navigation message from a received GNSS positioning signal, comprising:
a demodulator for demodulating the GNSS positioning signal into bit data; and
a navigation message acquiring unit for acquiring each of words constituting a subframe, creating, when at least one word required for acquiring the navigation message is failed to be acquired in the subframe, a supplemented subframe by supplementing the word failed to be acquired, with a word in another subframe acquired at a timing different from the word failed to be acquired, and acquiring the navigation message based on the supplemented subframe,
wherein when the supplemented subframe is created with words in a plurality of subframes, the navigation message acquiring unit acquires time-of-week data contained in a particular word of the subframe, and determines, based on the time-of-week data, a subframe to which each of words constituting another subframe from which time-of-week data is failed to be acquired belongs.

26. A mobile terminal for executing an application using a position of the terminal itself, comprising:
the GNSS receiving apparatus of claim 24; and
a positioning calculator for positioning the terminal position itself based on a navigation message obtained from a navigation message acquiring unit and a tracking result of the GNSS positioning signal.

27. The method of acquiring the navigation message of claim 16, further comprising:
detecting a head position of the subframe based on a unique bit pattern contained in the subframe; and
identifying a position of each of the words in the subframe based on the head position.

28. The method of acquiring the navigation message of claim 17, further comprising:
detecting a head position of the subframe based on a unique bit pattern contained in the subframe; and
identifying a position of each of the words in the subframe based on the head position.

29. The method of acquiring the navigation message of claim 18, further comprising:
detecting a head position of the subframe based on a unique bit pattern contained in the subframe; and
identifying a position of each of the words in the subframe based on the head position.

30. The method of acquiring the navigation message of claim 16, wherein the navigation message is an ephemeris, and
wherein when the ephemeris is updated, the supplemented subframe is created with a word acquired after the update.

31. The method of acquiring the navigation message of claim 17, wherein the navigation message is an ephemeris, and
wherein when the ephemeris is updated, the supplemented subframe is created with a word acquired after the update.

32. The method of acquiring the navigation message of claim 18, wherein the navigation message is an ephemeris, and
wherein when the ephemeris is updated, the supplemented subframe is created with a word acquired after the update.

33. The method of acquiring the navigation message of claim 16, wherein the subframe is constituted with a predetermined number of words, and
wherein the word is constituted with a bit data row with a predetermined number of bits.

34. The method of acquiring the navigation message of claim 17, wherein the subframe is constituted with a predetermined number of words, and
wherein the word is constituted with a bit data row with a predetermined number of bits.
